(19) United States
(12) Patent Application Publication
(10) Pub. No.: US 2024/0306108 A1
(43) Pub. Date: Sep. 12, 2024

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventors: Bin LIANG, Dongguan (CN); Zhe FU, Dongguan (CN)

(21) Appl. No.: 18/666,044

(22) Filed: May 16, 2024

Related U.S. Application Data
(63) Continuation of application No. PCT/CN2022/071417, filed on Jan. 11, 2022.

(51) Int. Cl. H04W 56/00; H04L 5/00

(52) U.S. Cl. CPC H04W 56/005; H04L 5/0051; H04W 56/0015

(57) ABSTRACT

A wireless communication method, a terminal device, and a network device are provided. The method includes that: the terminal device receives first configuration information and/or second configuration information, the first configuration information being sent by means of broadcast signaling, the second configuration information being sent by means of terminal dedicated signaling, the first configuration information being used for configuring whether the terminal device performs propagation delay compensation, and the second configuration information being used for configuring whether the terminal device performs the propagation delay compensation; and the terminal device determines, according to the first configuration information and/or the second configuration information, whether to perform the propagation delay compensation.

### CROSS-REFERENCE TO RELATED APPLICATION

This is a continuation application of International Patent Application No. PCT/CN2022/071417, filed on Jan. 11, 2022, entitled “WIRELESS COMMUNICATION METHOD, TERMINAL DEVICE, AND NETWORK DEVICE”, the disclosure of which is hereby incorporated by reference in its entirety.

### BACKGROUND

In order to support transmissions of services, such as the factory automation, the transport industry, the electrical power distribution, in the communication system, a concept of Time Sensitive Network (TSN) is introduced into the Industrial Internet of Things (IIOT) system. In the TSN system, the communication system is served as a TSN bridge to provide services for clock synchronization and service transmission between the TSN nodes. Therefore, it is necessary for the communication system to provide a lower delay guarantee and a higher accuracy for the clock synchronization. In order to satisfy the accuracy requirement, propagate delay compensation is required to be performed on the service to be transmitted. Configuration information of a propagate delay compensation manner may be transmitted by broadcast signaling or by terminal-dedicated signaling. When a network device may send multiple types of propagate delay compensation configurations, how to perform the propagate delay compensation is an urgent problem to be solved.

### SUMMARY

Embodiments of the present disclosure relates to a field of communications, in particular to, methods for wireless communication, a terminal device and a network device. Embodiments of the present disclosure provide methods for wireless communication, a terminal device and a network device.

In a first aspect, there is provided a method for wireless communication, including that: a terminal device receives first configuration information and/or second configuration information, where the first configuration information is transmitted through broadcast signaling, the second configuration information is transmitted through terminal-dedicated signaling, the first configuration information is used for configuring whether the terminal device performs a propagate delay compensation, and the second configuration information is used for configuring whether the terminal device performs the propagate delay compensation; and the terminal device determines, according to the first configuration information and/or the second configuration information, whether to perform the propagate delay compensation.

In a second aspect, there is provided a terminal device including a processor and a memory. The memory is configured to store a computer program, and the processor is configured to invoke and run the computer program stored in the memory to cause the terminal device to: receive first configuration information and/or second configuration information, wherein the first configuration information is sent through broadcast signaling, the second configuration information is sent through terminal-dedicated signaling, the first configuration information is used for configuring whether the terminal device performs a propagate delay compensation, and the second configuration information is used for configuring whether the terminal device performs the propagate delay compensation; and determine, according to the first configuration information and/or the second configuration information, whether to perform the propagate delay compensation.

In a third aspect, there is provided a network device including a processor and a memory. The memory is configured to store a computer program, and the processor is configured to invoke and run the computer program stored in the memory to cause the network device to: send target configuration information and/or target reference time information to a terminal device, wherein the target configuration information is used for configuring whether the terminal device performs propagate delay compensation, and the target reference time information is used for indicating reference time information used for the terminal device to perform the propagate delay compensation.

Based on the technical solution, the terminal device may receive a broadcast propagate delay compensation configuration (i.e. the first configuration information) and/or a terminal-dedicated propagate delay compensation configuration (i.e. the second configuration information); and further determine the target propagate delay compensation manner based on the first configuration information and/or the second configuration information.

### BRIEF DESCRIPTION OF THE DRAWINGS

FIG. 1 is a schematic diagram of an application scenario according to an embodiment of the present disclosure.

FIG. 2 is a network architecture diagram of a TSN network in which a 5th-Generation (5G) network is served as a TSN bridge.

FIG. 3 is a schematic diagram of a method for wireless communication according to an embodiment of the present disclosure.

FIG. 4 is a schematic diagram of determining a Round Trip Time (RTT) based on a Receive-Transport (RX-TX) manner.

FIG. 5 is a schematic diagram of another method for wireless communication according to an embodiment of the present disclosure.

FIG. 6 is a schematic block diagram of a terminal device according to an embodiment of the present disclosure.

FIG. 7 is a schematic block diagram of a network device according to an embodiment of the present disclosure.

FIG. 8 is a schematic block diagram of a communication device according to another embodiment of the present disclosure.

FIG. 9 is a schematic block diagram of a chip according to an embodiment of the present disclosure.

FIG. 10 is a schematic block diagram of a communication system according to an embodiment of the present disclosure.

### DETAILED DESCRIPTION

The technical solution of the embodiments of the present disclosure would be clearly and completely described in conjunction with the accompanying drawings in the embodiments of the present disclosure. It is apparent that the described embodiments are only part of the embodiments of the present disclosure, not all the embodiments. All other embodiments obtained by those of ordinary skill in the art with respect to the embodiments of the present disclosure without creative efforts all fall within the scope of protection of the present disclosure.

The technical solution of the embodiments of the present disclosure may be applied to various communication systems, such as: a Global System Of Mobile Communication (GSM) system, a Code Division Multiple Access (CDMA) system, a Wideband Code Division Multiple Access (WCDMA) system, a General Packet Radio Service (GPRS), a Long Term Evolution (LTE) system, an Advanced Long Term Evolution (LTE-A) system, a New Radio (NR) system, an evolution system for NR system, a LTE-based access to Unlicensed Spectrum (LTE-U) system, a NR-based access to Unlicensed Spectrum (NR-U) system, a Non-Terrestrial Networks (NTN) system, a Universal Mobile Telecommunication System (UMTS), a Wireless Local Area Network (WLAN), a Wireless Fidelity (Wi-Fi), a 5th-generation (5G) system or other communication systems.

Generally speaking, traditional communication systems support a limited number of connections and are easy to implement. However, with the development of communication technology, mobile communication systems will not only support traditional communication, but also support, for example, Device to Device (D2D) communication, Machine To Machine (M2M) communication, Machine Type Communication (MTC), Vehicle To Vehicle (V2V) communication, or V2X communication, etc. The embodiments of the present disclosure may also be applied to these communication systems.

Optionally, the communication system in the embodiments of the present disclosure may be applied to a Carrier Aggregation (CA) scenario, a Dual Connectivity (DC) scenario, and a Standalone (SA) network distribution scenario.

Optionally, the communication system in the embodiments of the present disclosure may be applied to an unlicensed spectrum, and the unlicensed spectrum may also be considered as a shared spectrum. Optionally, the communication system in the embodiments of the present disclosure may also be applied to a licensed spectrum, and the licensed spectrum may also be considered as a non-shared spectrum.

The embodiments of the present disclosure are described in connection with a network device and a terminal device. The terminal device may also be referred to as User Equipment (UE), an access terminal, a subscriber unit, a subscriber station, a mobile station, a mobile platform, a remote station, a remote terminal, a mobile device, a user terminal, a terminal, a wireless communication device, a user agent or a user device, etc.

The terminal device may be a Station (ST) in the WLAN, a cellular telephone, a cordless telephone, a Session Initiation Protocol (SIP) telephone, a Wireless Local Loop (WLL) station, a Personal Digital Assistant (PDA) device, a handheld device having a wireless communication function, a computing device or other processing device connected to a wireless modem, a vehicle-mounted device, a wearable device, a terminal device in a next generation communication system such as an NR network, or a terminal device in a future evolved Public Land Mobile Network (PLMN) network, etc.

In the embodiments of the present disclosure, the terminal device may be deployed on land, and include indoor or outdoor device, hand-held device, wearable device or vehicle-mounted device. The terminal device may also be deployed on the water (such as on the ships, etc.). The terminal device may also be deployed in the air (such as, in airplanes, in balloons and in satellites, etc.).

In the embodiments of the present disclosure, the terminal device may be a mobile phone, a Pad, a computer with wireless transceiver function, a Virtual Reality (VR) terminal device, an Augmented Reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home, etc.

By way of example and not limitation, in the embodiments of the present disclosure, the terminal device may also be a wearable device. The wearable device may also be referred to as a wearable smart device, which is a general term of wearable devices that are intelligently designed and developed by applying wearable technology to daily wear, such as, glasses, gloves, watches, clothing and shoes. The wearable device is a portable device that is worn directly on the body or integrated into the user's clothes or accessories. The wearable device is not only a kind of hardware device, but also realizes powerful functions through software support, data interaction and cloud interaction. The generalized wearable smart device has full functions and a large size, and the generalized wearable smart device may realize complete or partial functions without relying on smart phones, such as smart watches or smart glasses, and the generalized wearable smart device only focus on certain application functions and need to be used in conjunction with other devices (such as, smart phones), such as, various smart bracelets and smart jewelry for monitoring physical signs.

In the embodiments of the present disclosure, the network device may be a device configured to communicate with a mobile device, and the network device may be an access point (AP) in a WLAN, a Base Transceiver Station (BTS) in a GSM or CDMA, a NodeB (NB) in a WCDMA, an evolved Node B (eNB or eNodeB) in an LTE, a relay station or an access point, a vehicle-mounted device, a wearable device, a network device or a gNB in an NR network, a network device in a future evolved PLMN network or a network device in an NTN network, etc.

By way of example and not limitation, in the embodiments of the present disclosure, the network device may have mobility characteristics, for example, the network device may be a mobile device. Optionally, the network device may be a satellite, a balloon station. For example, the satellite may be a Low Earth Orbit (LEO) satellite, a Medium Earth Orbit (MEO) satellite, a Geostationary Earth Orbit (GEO) satellite, a High Elliptical Orbit (HEO) satellite, and the like. Optionally, the network device may also be a base station located on land, water, etc.

In the embodiments of the present disclosure, the network device may provide a service for a cell, and the terminal device communicates with the network device through transmission resources (e.g., frequency resources, or spectrum resources) used by the cell. The cell may be a cell corresponding to the network device (e.g., base station), and the cell may belong to a macro base station or a base station corresponding to a small cell. The small cell may include a metro cell, a micro cell, a Pico cell, a Femto cell, etc. These small cells have characteristics of small coverage and low transmission power, and the small cells are suitable for providing a high-speed data transmission service.

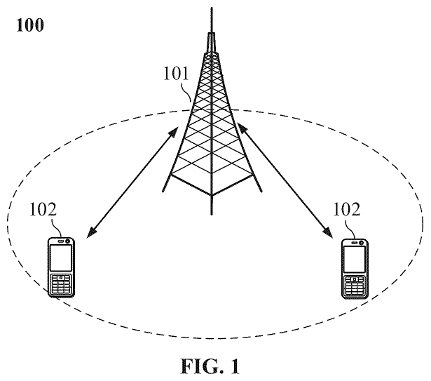

Exemplarily, the communication system 100 to which the embodiments of the present disclosure are applied is illustrated in FIG. 1. The communication system 100 may include a network device 101 that communicates with a terminal device 102 (or referred to as a communication terminal, or a terminal). The network device 101 may provide communication coverage for a particular geographic area and may communicate with terminal devices located within the coverage.

FIG. 1 exemplarily illustrates one network device and two terminal devices. Optionally, the communication system 100 may include multiple network devices, and other numbers of terminal devices may be included within the coverage of each network device, which is not limited by the embodiments of the present disclosure.

Optionally, the communication system 100 may also include other network entities, such as, a network controller, a mobility management entity, etc., which are not limited by the embodiments of the present disclosure.

It is to be understood that a device having a communication function in the network or system in the embodiments of the present disclosure may be referred to as a communication device. The communication system 100 illustrated in FIG. 1 is taken as an example, the communication device may include a network device 101 and a terminal device 102 that both have the communication function, and the network device 101 and the terminal device 102 may be the devices described above, which will not be described herein. The communication device may also include other devices in the communication system 100, such as, a network controller, a mobility management entity and other network entities, which are not limited in the embodiments of the present disclosure.

It is to be understood that the terms “system” and “network” are often used interchangeably herein. In the present disclosure, the term “and/or” is only an association relationship describing associated objects and represents that three relationships may exist. For example, A and/or B may represent three conditions: i.e., independent existence of A, existence of both A and B and independent existence of B. In addition, the character “/” in the present disclosure generally indicates that the relationship between the related objects is “or”.

It is to be understood that the reference to “indication” in the embodiments of the present disclosure may be a direct indication, may be an indirect indication, or may be indicative of an association. For example, A indicates B, which may mean that A directly indicates B, for example, B may be obtained through A; it may also mean that A indirectly indicates B, for example, A indicates C, and B may be obtained by C; and it may also indicate that there is an association between A and B.

In the description of the embodiments of the present disclosure, the term “correspondence” may mean that there is a direct correspondence or an indirect correspondence between the two, may also mean that there is an association relationship between the two, and may also be a relationship between indication and being indicated, configuration and being configured, etc.

In the embodiments of the present disclosure, in order to support the transmissions of the services, such as the factory automation, the transport industry, and intelligent power distribution in the 5G system, the concept of the TSN or the Time Sensitive Control (TSC) is introduced into the IIOT system. In the TSN system, the communication system 100 is served as the TSN bridge to provide services for the clock synchronization and the service transmission between the TSN nodes. Therefore, it is necessary for the communication system 100 to provide a lower delay guarantee and a higher accuracy for the clock synchronization.

FIG. 2 is a network architecture diagram of a TSN network in which a 5G network is served as a TSN bridge. The network architecture includes: a TSN System 110, a bridge at network side 120, a 5G system 130, a bridge at device side 140, and a TSN bridge/end device 150.

The TSN system 110 includes one Centralized User Configuration (CUC), one Centralized Network Configuration (CNC), and at least one TSN bridge or end device. The TSN system 110 is connected with the bridge at network side 120.

The bridge at network side 120 includes a control plane TSN translator and a user plane TSN translator. An Application Function (AF) is served as the control plane TSN translator that has a communication connection with the CNC in the TSN System 110. The user plane TSN translator has a communication connection with the TSN bridge or end device in the TSN System 110.

The 5G system 130 includes: a core network, a Radio Access Network (RAN), and a terminal. A user plane of the core network includes a User Plane Function (UPF); and a control plane of the core network includes: a Unified Data Management (UDM), a Network Exposure Function (NEF), Access and Mobility Management Function (AMF) entity, a Session Management Function (SMF), and a Policy Control Function (PCF).

The N1 interface is a reference point between the terminal and the AMF. The N2 interface is a reference point between the RAN and the AMF and is used for sending Non-Access Stratum (NAS) messages. The N3 interface is a reference point between the RAN and the UPF and is used for transmitting data of the user plane. The N4 interface is a reference point between the SMF and the UPF, and is used for transmitting information, such as, tunnel identification information, data cache indication information, and downlink data notification messages that are under the connection through N3. The N6 interface is a reference point between the UPF and the user plane TSN translator and is used for transmitting the data of the user plane, etc. The N8 is a reference point between the UDM and the AMF. The N10 is a reference point between the UDM and the SMF. The N11 is a reference point between the AMF and the SMF.

The bridge at device side 140 has a communication connection with a terminal in the 5G System 130. The bridge at device side 140 includes a device side TSN translator. The bridge at device side 140 also has a communication connection with the TSN bridge/end device 150.

As can be seen from FIG. 2, in the TSN network, the 5G system 130 is a path for transmitting TSN services, so that the 5G system needs to support the transmission of the TSN services and support the time synchronization requirement of the TSN network to transmit the services within the required duration. In view of this, the 5G system 130 needs to provide the lower delay guarantee and the higher accuracy for the clock synchronization, so that when the factory automation services are transmitted in the 5G network, the operation of each point operated by the machine and the continuation of operations are accurate and satisfy the time requirement.

In the 5G system, the TSN time is indicated through a reference time information field (referenceTimeInfo-r16) in System Information Block (SIB) signaling. The reference time information field includes: system frame number information, absolute time information, etc., and has an indication accuracy of 10 ns.

In some scenarios, based on the requirements for the transmission of the TSN services, when the TSN services are transmitted in the 5G system, the accuracy requirement for the time synchronization is required to be less than 900 ns. In order to meet the accuracy requirement herein, a propagate delay compensation is required.

In the process of the time synchronization or the Propagate Delay Compensation (PDC), two manners may be considered: one is a Timing Advance (TA)-based manner and the other is a Round Trip Time (RTT)-based manner. These two manners are used for obtaining a propagate delay compensation value and performing the accurate synchronization with the network. For the TA-based PDC, the propagate delay compensation may be performed based on TA information. For the RTT-based PDC, the propagate delay may be determined by a round trip delay between the network device and the terminal device, and then is compensated.

Both the TA-based PDC and the RTT-based PDC need to use the reference time information. The result of the propagate delay compensation may be more accurate based on the accurate reference time information.

The configuration information of the propagate delay compensation manner and reference time information may be transmitted through broadcast signaling or through terminal-dedicated signaling. When the network device may send multiple propagate delay compensation configurations and multiple pieces of reference time information, how to perform the propagate delay compensation is an urgent problem to be solved.

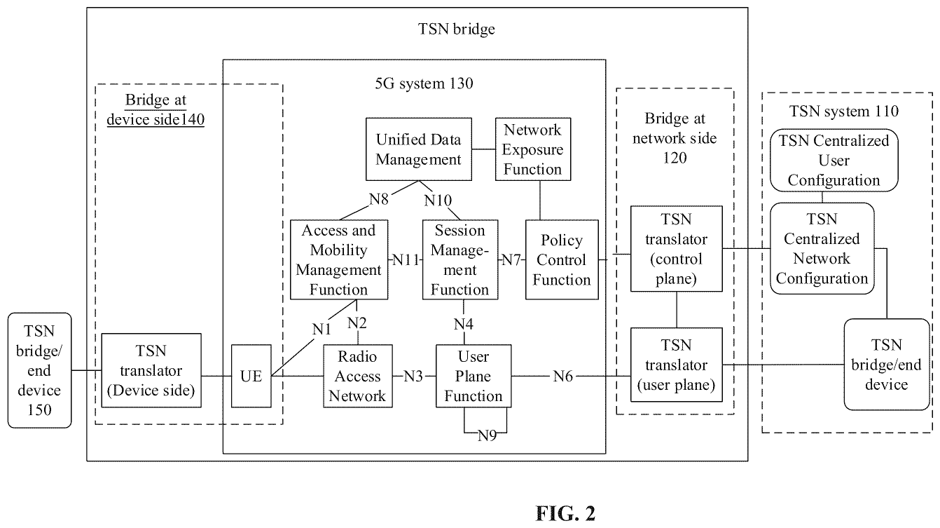

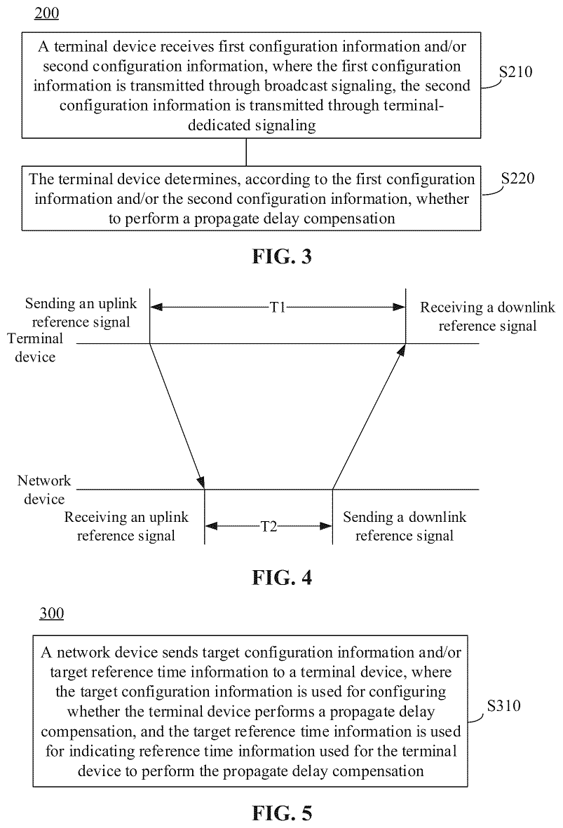

FIG. 3 is a schematic flowchart of a method 200 for wireless communication according to an embodiment of the present disclosure. The method 200 may be performed by the terminal device in the communication system as illustrated in FIG. 1. As illustrated in FIG. 3, the method 200 may include at least some contents of following operations S210 and S220.

In operation S210, the terminal device receives first configuration information and/or second configuration information, where the first configuration information is transmitted through broadcast signaling, the second configuration information is transmitted through terminal-dedicated signaling.

In operation S220, according to the first configuration information and/or the second configuration information, it is determined whether the propagate delay compensation is to be performed.

In some embodiments, the terminal device performs the propagate delay compensation for time alignment between the terminal device and the network device, or for time alignment of the TSN system.

In some embodiments, the propagate delay compensation performed by the terminal device is adapted to all receiving and transmitting flows of the terminal device or the network device.

In some embodiments, the broadcast signaling may include, but is not limited to, system information. That is to say, the first configuration information may be considered to be non-terminal-dedicated. For example, the first configuration information may be cell-level.

As an example, the system message may include an SIB9.

In some embodiments, the first configuration information is also referred to as a broadcast propagate delay compensation configuration.

In some embodiments, the terminal-dedicated signaling may include, but is not limited to, Radio Resource Control (RRC) signaling, a downlink information transfer command (DLinformationtransfer). That is to say, the second configuration information may be terminal-dedicated or may be terminal group-dedicated to which the terminal device belongs. That is to say, the second configuration information may be transmitted at a granularity of terminal device or at a granularity of terminal group.

In some embodiments, the second configuration information is also referred to as a terminal-dedicated propagate delay compensation configuration.

In some embodiments, the first configuration information is used for configuring whether the terminal device performs the propagate delay compensation and/or configuring a propagate delay compensation manner adopted by the terminal device, such as the TA-based PDC manner or the RTT-based PDC manner.

In some embodiments, the second configuration information is used for configuring whether the terminal device performs the propagate delay compensation and/or configuring a propagate delay compensation manner adopted by the terminal device, such as the TA-based PDC manner or the RTT-based PDC manner.

In some embodiments of the present disclosure, the operation S220 may include that:

the terminal device determines whether to perform the propagate delay compensation according to a reception of the first configuration information and the second configuration information, and/or according to contents configured by the first configuration information and the second configuration information.

In some embodiments, when the terminal device has not received any one of the first configuration information and the second configuration information, it is determined that the propagate delay compensation is not to be performed.

In other embodiments, in a case where the terminal device has received at least one of: the first configuration information or the second configuration information, when configuration information used for the terminal device to perform the propagate delay compensation exists in the at least one piece of configuration information, the terminal device determines to perform the propagate delay compensation; or when the configuration information used for the terminal device to perform the propagate delay compensation does not exist in the at least one piece of configuration information, the terminal device determines not to perform the propagate delay compensation.

For a case 1, the terminal device has received only the first configuration information.

In this case, according to the first configuration information, the terminal device determines whether to perform the propagate delay compensation, or may determine not to perform the propagate delay compensation.

For example, when the first configuration information is used for configuring that the propagate delay compensation is to be performed, the terminal device determines to perform the propagate delay compensation; or when the first configuration information is used for configuring that the propagate delay compensation is not to be performed, the terminal device determines not to perform the propagate delay compensation.

For a case 2, the terminal device has received only the second configuration [0070] information.

In this case, according to the second configuration information, the terminal device determines whether to perform the propagate delay compensation, or may determine not to perform the propagate delay compensation.

For example, when the second configuration information is used for configuring that the propagate delay compensation is to be performed, the terminal device determines to perform the propagate delay compensation; or when the second configuration information is used for configuring that the propagate delay compensation is not to be performed, the terminal device determines not to perform the propagate delay compensation.

For a case 3, the terminal device has received the first configuration information and the second configuration information.

In this case, the terminal device may determine, according to a specific configuration indicated by the first configuration information and the second configuration information, whether to perform the propagate delay compensation.

For example, when both the first configuration information and the second configuration information configure that the propagate delay compensation is not to be performed, the terminal device determines not to perform the propagate delay compensation.

For another example, when the first configuration information configures that the propagate delay compensation is to be performed and the second configuration information configures that the propagate delay compensation is not to be performed, the terminal device determines to perform the propagate delay compensation; or, when the first configuration information configures that the propagate delay compensation is not to be performed and the second configuration information configures that the propagate delay compensation is to be performed, the terminal device determines to perform the propagate delay compensation.

For another example, when the first configuration information configures that the propagate delay compensation is to be performed and the second configuration information configures that the propagate delay compensation is to be performed, the terminal device determines to perform the propagate delay compensation.

That is to say, in a case where the configuration information used for configuring the terminal device to perform the propagate delay compensation exists, the terminal device preferentially selects performing the propagate delay compensation, which is beneficial to ensuring the accuracy requirement for the clock between the terminal device and the network device.

In other embodiments of the present disclosure, the operation S220 may include that:
the terminal device determines, according to target configuration information in the first configuration information and/or the second configuration information, whether to perform the propagate delay compensation.

In some embodiments, which one (i.e. the target configuration information) of the first configuration information and/or the second configuration information to be used for determining whether to perform the propagate delay compensation, may be determined according to the reception (e.g. whether has been received, or reception time, etc.) of the first configuration information and the second configuration information, or may be determined according to predefined information, or may be determined according to a configuration from the network device.

In some cases, when only one piece of configuration information in the first configuration information and the second configuration information has been received, the terminal device may determine whether to perform the propagate delay compensation according to the one piece of configuration information.

For example, when the terminal device has received only the first configuration information, the terminal device may determine, according to the first configuration information, whether to perform the propagate delay compensation. That is to say, the target configuration information is the first configuration information.

For another example, when the terminal device has received only the second configuration information, the terminal device may determine, according to the second configuration information, whether to perform the propagate delay compensation. That is to say, the target configuration information is the second configuration information.

In other cases, the terminal device has received the first configuration information and the second configuration information.

For the first manner, the terminal device may determine, according to the second configuration information, whether to perform the propagate delay compensation. The target configuration information is second configuration information.

Since the terminal-dedicated configuration information is configured for the terminal device, it is more adaptable to the terminal device. Therefore, when two pieces of configuration information are received, the terminal device determines, preferentially according to the terminal-dedicated configuration information, whether to perform the propagate delay compensation, thereby selecting a propagate delay compensation manner more adaptable to the terminal device.

For the second manner, it is determined, according to the first configuration information or the second configuration information, whether the propagate delay compensation is to be performed. The target configuration information is the first configuration information or the second configuration information.

That is to say, in the case where two pieces of configuration information are received, the terminal device may randomly select one piece of configuration information to determine whether to perform the propagate delay compensation.

For the third manner, it is determined, according to predefined configuration information in the first configuration information and the second configuration information, whether the propagate delay compensation is to be performed. That is to say, the target configuration information is the predefined configuration information in the first configuration information and the second configuration information.

In some embodiments, the predefined configuration information may be used for indicating configuration information that is selected preferentially between the first configuration information and the second configuration information. For example, the predefined configuration information may be the first configuration information or may also be the second configuration information.

For the fourth manner, it is determined, according to configuration information with a later reception time between the first configuration information and the second configuration information, whether the propagate delay compensation is to be performed. That is to say, the target configuration information is the configuration information with the later reception time between the first configuration information and the second configuration information.

For example, when the first configuration information has been received after the second configuration information, it is determined, according to the first configuration information, whether the propagate delay compensation is to be performed.

For another example, when the second configuration information has been [0094] received after the first configuration information, it is determined, according to the second configuration information, whether the propagate delay compensation is to be performed.

For the fifth manner, it is determined, according to configuration information indicated by the network device in the first configuration information and the second configuration information, whether the propagate delay compensation is to be performed. That is to say, the target configuration information is the configuration information indicated by the network device, in the first configuration information and the second configuration information.

In some embodiments, the configuration information indicated by the network device may be configuration information that is selected preferentially between the first configuration information and the second configuration information. For example, the configuration information indicated by the network device may be the first configuration information or may also be the second configuration information.

For example, when the network device indicates that the first configuration information is the configuration information that is selected preferentially, the propagate delay compensation is to be performed according to the first configuration information. For another example, when the network device indicates that the second configuration information is the configuration information that is selected preferentially, the propagate delay compensation is to be performed according to the second configuration information.

In some embodiments, in a case where the terminal device determines, according to the first configuration information, whether to perform the propagate delay compensation, when the first configuration information is used for configuring the terminal device to perform the propagate delay compensation, the terminal device determines to perform the propagate delay compensation; or when the first configuration information is used for configuring the terminal device not to perform the propagate delay compensation, the terminal device determines not to perform the propagate delay compensation.

In some embodiments, in a case where the terminal device determines, according to the second configuration information, whether to perform the propagate delay compensation, when the second configuration information is used for configuring the terminal device to perform the propagate delay compensation, the terminal device determines to perform the propagate delay compensation; or when the second configuration information is used for configuring the terminal device not to perform the propagate delay compensation, the terminal device determines not to perform the propagate delay compensation.

In some embodiments, the terminal device may also determine, according to the first configuration information or the second configuration information, a specific manner of the propagate delay compensation, such as, the TA-based PDC manner or the RTT-based PDC manner.

In some embodiments of the present disclosure, the method 200 further includes that:
the terminal device receives first reference time information and/or second reference time information, where the first reference time information is sent through the broadcast signaling, and the second reference time information is sent through the terminal-dedicated signaling;
The terminal device performs the propagate delay compensation according to the first reference time information and/or the second reference time information.

In some embodiments, the first reference time information may be, for example, an absolute time, such as, a year, a month, a day, an hour, a minute, a second, a millisecond; or may be another time identifier, such as, a slot serial number.

In some embodiments, the second reference time information may be, for example, an absolute time, such as a year, month, day, hour, minute, second, millisecond, or another time identifier, such as a time slot serial number.

In some embodiments, the broadcast signaling may include system information, such as, but not limited to, the System Information Block 9 (SIB9).

For example, the SIB9 may include the reference time information (referenceTimeInfo) used for determining the first reference time information. For example, the reference time information in the SIB9 may be determined as the first reference time information.

In some embodiments, the first reference time information may also be referred to as broadcast reference time information, and common reference time information.

In some embodiments, the terminal-dedicated signaling may include, but is not limited to, the RRC signaling, the downlink information transfer command (DLinformationtransfer). That is to say, the second reference time information may be terminal-dedicated or may be terminal group-dedicated to which the terminal device belongs. That is to say, the second reference time information may be transmitted at the granularity of terminal device or at the granularity of terminal group.

For example, the DLinformationtransfer may include the reference time information used for determining the second reference time information. For example, the reference time information in the DLinformationtransfer may be determined as the second reference time information.

In some embodiments, the second reference time information is also referred to as terminal-dedicated reference time information.

It is to be understood that in the embodiment of the present disclosure, the first configuration information and the first reference time information may be transmitted through the same broadcast signaling, or may be transmitted through different broadcast signaling. The order for transmitting the first configuration information and the first reference time information is not limited in the present disclosure.

It is also to be understood that, in the embodiment of the present disclosure, the second configuration information and the second reference time information may be transmitted through the same terminal-dedicated signaling, or may be transmitted through different terminal-dedicated signaling. The order for transmitting the second configuration information and the second reference time information is not limited in the present disclosure.

In some embodiments, each of the first reference time information and the second reference time information has certain correspondence with the first configuration information and the second configuration information.

For example, the first reference time information may be applied to the propagate delay compensation configured by the first configuration information, or may also be applied to the propagate delay compensation configured by the second configuration information.

As another example, the second reference time information may be applied to the propagate delay compensation configured by the second configuration information, or may also be applied to the propagate delay compensation configured by the first configuration information.

That is to say, when it is determined, according to the first configuration information, that the propagate delay compensation is to be performed, the propagate delay compensation is to be performed according to the first reference time information preferentially, or as a secondary option, the propagate delay compensation is to be performed according to the second reference time information. When it is determined, according to the second configuration information, that the propagate delay compensation is to be performed, the propagate delay compensation is to be performed according to the second reference time information preferentially, or as a secondary option, the propagate delay compensation is to be performed according to the first reference time information.

In some embodiments, the terminal device may determine, according to the reception of the first reference time information and the second reference time information, target reference time information used for performing the propagate delay compensation.

For a case X, the terminal device has received only one piece of reference time information in the first reference time information and the second reference time information.

In this case, as an implementation, the terminal device may perform the propagate delay compensation according to the one piece of reference time information.

For example, when only the first reference time information has been received, the propagate delay compensation may be performed according to the first reference time information.

For another example, when only the second reference time information has been received, the propagate delay compensation may be performed according to the second reference time information.

For a case Y, the terminal device has received the first reference time information and the second reference time information.

As an implementation, the terminal device may perform the propagate delay compensation according to the first reference time information.

That is to say, in a case where two kinds of reference time information are received, the propagate delay compensation is to be performed according to the first reference time information preferentially.

As another implementation, the terminal device may perform the propagate delay compensation according to the second reference time information.

That is to say, in a case where two kinds of reference time information are received, the propagate delay compensation is to be performed according to the second reference time information preferentially.

Since the terminal-dedicated reference time information is configured for the terminal device, it is more adaptable to the terminal device. Therefore, when two kinds of reference time information are received, the terminal-dedicated reference time information is preferentially selected to perform the propagate delay compensation, thereby selecting the reference time information more adaptable for the terminal device to perform the propagate delay compensation.

As yet another implementation, the propagate delay compensation is to be performed according to the first reference time information or the second reference time information. That is to say, when two kinds of reference time information are received, one kind of reference time information is randomly selected to perform the propagate delay compensation.

As yet another implementation, the terminal device performs the propagate delay compensation according to target reference time information in the first reference time information and the second reference time information. The target reference time information may be determined according to at least one of:

configuration information on which the determination of performing the propagate delay compensation made by the terminal device depends, a reception time of the first reference time information and a reception time of the second reference time information, predefined reference time information or reference time information configured by the network device.

In some embodiments, the predefined reference time information may be any one of the first reference time information and the second reference time information. For example the predefined reference time information may be the first reference time information or may be the second reference time information. That is to say, it is possible to predefine which reference time information is used for the terminal device to perform the propagate delay compensation.

In some embodiments, the reference time information configured by the network device may be any one of the first reference time information and the second reference time information. For example, the reference time information configured by the network device may be the first reference time information, or may be the second reference time information. That is to say, the network device may configure which reference time information is used for the terminal device to perform the propagate delay compensation.

As an example, the propagate delay compensation is to be performed according to reference time information with a later reception time between the first reference time information and the second reference time information. That is to say, the target reference time information is the reference time information with the later reception time between the first reference time information and the second reference time information.

As another example, the propagate delay compensation is to be performed according to predefined reference time information in the first reference time information and the second reference time information. That is to say, the target reference time information is the predefined reference time information in the first reference time information and the second reference time information.

As yet another example, the propagate delay compensation is to be performed according to reference time information, configured by the network device, in the first reference time information and the second reference time information. That is to say, the target reference time information is the reference time information configured by the network device, in the first reference time information and the second reference time information.

As yet another example, in a case where it is determined, according to the first configuration information, that the propagate delay compensation is to be performed, the propagate delay compensation is to be performed according to the first reference time information or the second reference time information, or according to the reference time information with the later reception time between the first reference time information and the second reference time information, or according to the predefined reference time information, or according to the reference time information configured by the network device.

As yet another example, in a case where it is determined, according to the second configuration information, that the propagate delay compensation is to be performed, the propagate delay compensation is to be performed according to the second reference time information or the first reference time information, or according to the reference time information with the later reception time between the first reference time information and the second reference time information, or according to the predefined reference time information, or according to the reference time information configured by the network device.

To sum up, in the embodiment of the present disclosure, the terminal device may determine two aspects: the propagate delay compensation manner and the reference time information used for performing the propagate delay compensation. It is to be understood that the two aspects may be implemented separately or in combination, which is not limited in the present disclosure.

Hereinafter, two aspects will be described in conjunction with typical examples but the present disclosure is not limited thereto.

Embodiment 1: a determination of the propagate delay compensation manner

For an embodiment 1-1, the terminal device has received one propagate delay compensation configuration, such as, the first configuration information or the second configuration information.

In this case, according to the received configuration information, the terminal may determine whether to perform the propagate delay compensation, or determine not to perform the propagate delay compensation.

For an embodiment 1-2, the terminal device has received two propagate delay compensation configurations, such as, the first configuration information and the second configuration information.

In some embodiments, the terminal device determines, according to the contents configured by the first configuration information and the second configuration information, whether to perform the propagate delay compensation.

For example, when the first configuration information configures that the propagate delay compensation is to be performed, and the second configuration information configures that the propagate delay compensation is not to be performed, the terminal device determines, according to the first configuration information, to perform the propagate delay compensation.

For another example, when the first configuration information configures that the propagate delay compensation is not to be performed, and the second configuration information configures that the propagate delay compensation is to be performed, the terminal device determines, according to the second configuration information, to perform the propagate delay compensation.

For another example, when both the first configuration information and the second configuration information configure that the propagate delay compensation is not to be performed, the terminal device determines not to perform the propagate delay compensation.

For another example, when both the first configuration information and the second configuration information configure that the propagate delay compensation is to be performed, the terminal device determines to perform the propagate delay compensation.

In other embodiments, the terminal device determines, according to the target configuration information in the first configuration information and the second configuration information, whether to perform the propagate delay compensation.

Optionally, the target configuration information may be determined according to at least one of: the reception of the first configuration information and the second configuration information, predefined information, a configuration from the network device.

For example, it is determined, according to the second configuration information, whether the propagate delay compensation is to be performed. That is to say, the target configuration information is the second configuration information.

For another example, it is determined, according to any one of the first configuration information and the second configuration information, whether the propagate delay compensation is to be performed. That is to say, the target configuration information is any one of the first configuration information and the second configuration information.

For another example, it is determined, according to the configuration information with the later reception time between the first configuration information and the second configuration information, whether the propagate delay compensation is to be performed. That is to say, the target configuration information is the configuration information with the later reception time between the first configuration information and the second configuration information.

For another example, it is determined, according to the predefined configuration information in the first configuration information and the second configuration information, whether the propagate delay compensation is to be performed. That is to say, the target configuration information is the predefined configuration information in the first configuration information and the second configuration information.

For another example, it is determined, according to the configuration information indicated by the network device which is in the first configuration information and the second configuration information, whether the propagate delay compensation is to be performed. That is to say, the target configuration information is the configuration information indicated by the network device, in the first configuration information and the second configuration information.

In a case where it is determined, according to the first configuration information, whether the propagate delay compensation is to be performed, when the first configuration information configures that the propagate delay compensation is to be performed, the terminal device determines to perform the propagate delay compensation; when the first configuration information configures that the propagate delay compensation is not to be performed, the terminal device determines not to perform the propagate delay compensation.

In a case where it is determined, according to the second configuration information, whether the propagate delay compensation is to be performed, when the second configuration information configures that the propagate delay compensation is to be performed, the terminal device determines to perform the propagate delay compensation; when the second configuration information configures that the propagate delay compensation is not to be performed, the terminal device determines not to perform the propagate delay compensation.

embodiment 2: a determination of the reference time information

For an embodiment 2-1, the terminal device has received one piece of reference time information, such as, the first reference time information or the second reference time information

In this case, when the terminal device determines to perform the propagate delay compensation, then the terminal device performs the propagate delay compensation according to the received one piece of reference time information; or when the terminal device determines not to perform the propagate delay compensation, then the terminal device does not perform the propagate delay compensation.

For a case A, the terminal device has received one piece of reference time information, such as, the first reference time information, and has received one propagate delay compensation configuration, such as the first configuration information.

For a case A-1, the first configuration information configures the terminal device not to perform the propagate delay compensation, and the terminal device determines not to perform the propagate delay compensation.

For a case A-2, the first configuration information configures that the propagate delay compensation is to be performed, and the terminal device determines to perform the propagate delay compensation. In this case, the propagate delay compensation may be performed according to the first reference time information.

For a case B, the terminal device has received one piece of reference time information, such as the first reference time information, and has received one propagate delay compensation configuration, such as the second configuration information.

For a case B-1, the second configuration information configures the terminal device not to perform the propagate delay compensation, and the terminal device determines not to perform the propagate delay compensation.

For a case B-2, the second configuration information configures that the propagate delay compensation is to be performed, and the terminal device determines to perform the propagate delay compensation.

In this case, the propagate delay compensation is to be performed according to the first reference time information.

For a case C, the terminal device has received one piece of reference time information, such as the second reference time information, and has received one propagate delay compensation configuration, such as the first configuration information.

For a case C-1, the first configuration information configures that the propagate delay compensation is not to be performed, and the terminal device determines not to perform the propagate delay compensation.

For a case C-2: the first configuration information configures that the propagate delay compensation is to be performed, and the terminal device determines to perform the propagate delay compensation. In this case, the propagate delay compensation is to be performed according to the second reference time information.

For a case D, the terminal device has received one piece of reference time information, such as the second reference time information, and has received one propagate delay compensation configuration, such as the second configuration information.

For a case D-1, the second configuration information configures the terminal device not to perform the propagate delay compensation, and the terminal device determines not to perform the propagate delay compensation.

For a case D-2, the second configuration information configures that the propagate delay compensation is to be performed, and the terminal device determines to perform the propagate delay compensation. In this case, the propagate delay compensation is to be performed according to the second reference time information.

For an embodiment 2-2, the terminal device has received two pieces of reference time information, such as the first reference time information and the second reference time information

In some implementations, when both the first configuration information and the second configuration information configure the terminal device not to perform the propagate delay compensation, in this case, the terminal device determines not to perform the propagate delay compensation.

In some implementations, when the terminal device determines, according to the first configuration information, to perform the propagate delay compensation, the propagate delay compensation is to be performed according to the first reference time information or the second reference time information; according to the reference time information with the later reception time between the first reference time information and the second reference time information; or according to the predefined reference time information in the first reference time information and the second reference time information; or according to the reference time information configured by the network device in the first reference time information and the second reference time information.

In other implementations, when the terminal device determines, according to the second configuration information, to perform the propagate delay compensation, the propagate delay compensation is to be performed according to the second reference time information or the first reference time information; according to the reference time information with the later reception time between the first reference time information and the second reference time information; or according to the predefined reference time information in the first reference time information and the second reference time information; or according to the reference time information configured by the network device in the first reference time information and the second reference time information.

For a case E, the terminal device has received two pieces of reference time information, such as the first reference time information and the second reference time information, and has received two propagate delay compensation configurations, such as the first configuration information and the second configuration information.

For a case E-1, both the first configuration information and the second configuration information configure the terminal device not to perform the propagate delay compensation, and the terminal device determines not to perform the propagate delay compensation.

For a case E-2, both the first configuration information and the second configuration information configure the terminal device to perform the propagate delay compensation, and the terminal device determines to perform the delay compensation. In this case, the propagate delay compensation is to be performed according to the second reference time information, or the first reference time information, or the predefined reference time information, or the reference time information configured by the network device.

For a case E-3, the first configuration information configures the terminal device to perform the propagate delay compensation, the second configuration information configures the terminal device not to perform the propagate delay compensation, and the terminal device determines to perform the propagate delay compensation. In this case, the terminal device may perform the propagate delay compensation according to the first reference time information, or the propagate delay compensation is to be performed according to the second reference time information.

For a case E-4, the first configuration information configures the terminal device not to perform the propagate delay compensation, the second configuration information configures the terminal device to perform the propagate delay compensation, and the terminal device determines to perform the propagate delay compensation. In this case, the terminal device may perform the propagate delay compensation according to the second reference time information, or the propagate delay compensation is to be performed according to the first reference time information.

For a case F, the terminal device has received two pieces of reference time information, such as the first reference time information and the second reference time information, and has received one propagate delay compensation configuration, such as the first configuration information.

For a case F-1, the first configuration information configures the terminal device not to perform the propagate delay compensation, and the terminal device determines not to perform the propagate delay compensation.

For a case F-2, the first configuration information configures that the propagate delay compensation is to be performed, and the terminal device determines to perform the propagate delay compensation. In this case, the propagate delay compensation is to be performed according to the first reference time information, or the second reference time information, or the predefined reference time information, or the reference time information configured by the network device.

For a case G, the terminal device has received two pieces of reference time information, such as the first reference time information and the second reference time information, and has received one propagate delay compensation configuration, such as the second configuration information.

For a case G-1, the second configuration information configures the terminal device not to perform the propagate delay compensation, and the terminal device determines not to perform the propagate delay compensation.

For a case G-2, the second configuration information configures that the propagate delay compensation is to be performed, and the terminal device determines to perform the propagate delay compensation. In this case, the propagate delay compensation is to be performed according to the second reference time information, or the first reference time information, or the predefined reference time information, or the reference time information configured by the network device.

In some embodiments, the amount of the propagate delay compensation for the terminal device to perform the propagate delay compensation may be determined based on the RTT or based on the TA.

For example, for the RTT, the amount of the propagate delay compensation may be determined based on a manner of Receive-Transport (RX-TX) positioning.

For example, an RTT between a terminal device and a network device may be determined by sending and receiving reference signals between the terminal device and the network device.

As illustrated in FIG. 4, the terminal device may send an uplink reference signal to the network device, and the network device may receive a downlink reference signal sent by the terminal device. Furthermore, the network device may send a downlink reference signal to the terminal device, and the terminal device may receive the downlink reference signal sent by the network device. The terminal device may determine first time interval information T1 based on a transmission time of the uplink reference signal and a reception time of the downlink reference signal, and the network device may determine second time interval information T2 based on a reception time of the uplink reference signal and a transmission time of the downlink reference signal.

As an example, the amount of the propagate delay compensation may be determined according to the first time interval information T1 and the second time interval information T2. For example, the amount of the propagate delay compensation is (T1−T2)/2.

As another example, the amount of the propagate delay compensation is determined according to the TA. For example, the amount of the propagate delay compensation is TA/2.

Optionally, after the amount of the propagate delay compensation amount is obtained, the amount of the propagate delay compensation may be further adjusted according to the target reference time information, and the flows of the transmission or the reception may further performed based on the adjusted amount of the propagate delay compensation.

To sum up, the embodiment of the present disclosure provides a manner for determining whether the terminal device performs the propagate delay compensation in the case where multiple types of propagate delay compensation configurations may exist, and a manner for determining the reference time information used for the terminal device to perform the propagate delay compensation in the case where multiple types of reference time information for the propagate delay compensation exist. In this way, the flow of the propagate delay compensation is improved and it is beneficial to satisfying the accuracy requirement for the clock between the terminal device and the network device.

FIG. 5 is a schematic flowchart of a method 300 for wireless communication according to another embodiment of the present disclosure. The method 300 may be performed by the network device in the communication system as illustrated in FIG. 1. As illustrated in FIG. 3, the method 300 includes at least some contents of following operation S310.

In operation S310, the network device sends target configuration information and/or target reference time information to the terminal device.

In some embodiments, the target configuration information is used for configuring whether the terminal device performs the propagate delay compensation and/or the manner of performing the propagate delay compensation, such as RTT-based manner or TA-based manner, etc.

In some embodiments, the target reference time information is used for indicating the reference time information used for the terminal device to perform the propagate delay compensation.

In some embodiments, the target reference time information may be, for example, an absolute time, such as a year, a month, a day, a hour, a second, a millisecond, or may be another time identifier, such as a slot serial number.

In some embodiments of the present disclosure, the target configuration information and the target reference time information may be configured according to a certain constraint relationship, which is beneficial for the terminal device to use appropriate reference time information to perform the propagate delay compensation at different stages.

In some embodiments, the target configuration information is the first configuration information, the first configuration information is transmitted through the broadcast signaling, and the target reference time information is the first reference time information, the first reference time information is transmitted through the broadcast signaling.

The specific implementations of the first configuration information and the first reference time information are referred to the related description in the method 200, which will not be described herein.

That is to say, in the case where the network device configures, through the first configuration information, the terminal device to perform the propagate delay compensation, the network device configure the first reference time information for the terminal device, so that the terminal device performs the propagate delay compensation according to the first reference time information.

In some embodiments, the target configuration information is the second configuration information, the second configuration information is configured through the terminal-dedicated signaling, The target reference time information is the second reference time information or the first reference time information, the second reference time information is transmitted by terminal-dedicated signaling, and the first reference time information is transmitted through the broadcast signaling.

The specific implementations of the second configuration information and the second reference time information are referred to the related description in the method 200, which will not be described herein.

That is to say, in the case where the network device configures, through the second configuration information, the terminal device to perform the propagate delay compensation, the network device may preferentially configure the second reference time information for the terminal device, or the network device may configure the first reference time information for the terminal device, so that the terminal device performs the propagate delay compensation according to the appropriate reference time information.

That is to say, the first reference time information is used for the propagate delay compensation configured by the first configuration information or the second configuration information, and the second reference time information is used for the propagate delay compensation configured by the second configuration information. Optionally, the second reference time information may also be used for the propagate delay compensation configured by the first configuration information.

In some embodiments, when the target configuration information includes the first configuration information and the second configuration information, i.e., the network device sends two propagate delay compensation configurations to the terminal device, the method 300 further includes that:

the network device sends third configuration information to the terminal device, where the third configuration information is used for configuring: configuration information used for determining whether the propagate delay compensation is to be performed in the first configuration information and the second configuration information.

That is to say, the network device may configure for the terminal device: which one of the first configuration information and the second configuration information to be used for determining whether to perform the propagate delay compensation.

Optionally, the third configuration information is sent before the first configuration information and the second configuration information.

Optionally, the third configuration information may be sent through the broadcast signaling or the RRC signaling.

In other embodiments, the terminal device may also determine, according to the predefined information, which one of the first configuration information and the second configuration information to be used for determining whether to perform the propagate delay compensation. In this case, the network device may not need to send the third configuration information to the terminal device.

In some embodiments of the present disclosure, the target reference time information includes the first reference time information and the second reference time information, i.e. the network device sends two pieces of reference time information to the terminal device. In this case, the method 300 further includes that:

the network device sends fourth configuration information to the terminal device, where the fourth configuration information is used for configuring: reference time information used for performing the propagate delay compensation in the target reference time information.

That is to say, the network device may configure for the terminal device: which one of the first reference time information and the second reference time information to be used for determining whether to perform the propagate delay compensation.

Optionally, the fourth configuration information is sent before the first reference time information and the second reference time information.

Optionally, the fourth configuration information may be sent through the broadcast signaling or the RRC signaling.

In other embodiments, the terminal device may also determine, according to the predefined information, which one of the first reference time information and the second reference time information to be used for determining whether to perform the propagate delay compensation. In this case, the network device may not need to send the fourth configuration information to the terminal device.

To sum up, in the embodiment of the present disclosure, the network device may configure the propagate delay compensation configuration and the reference time information configuration that satisfy the constraint relationship for the terminal device, which is beneficial for the terminal device to select appropriate reference time information to perform the propagate delay compensation at different stages, and is beneficial to satisfying the accuracy requirement for the clock between the terminal device and the network device.

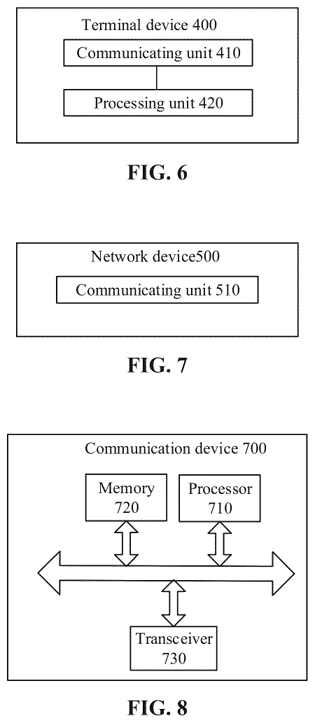

The method embodiments of the present disclosure have been described in detail above with reference to FIG. 3 to FIG. 5, and the apparatus embodiments of the present disclosure will be described in detail below with reference to FIG. 6 to FIG. 10. It is to be understood that the apparatus embodiments correspond to the method embodiments, and similar descriptions may refer to the method embodiments.

FIG. 6 illustrates a schematic block diagram of a terminal device 400 according to an embodiment of the present disclosure. As illustrated in FIG. 6, the terminal device 400 includes a communicating unit 410 and processing unit 420.

The communicating unit 410 is configured to receive first configuration information and/or second configuration information, where the first configuration information is sent through broadcast signaling, the second configuration information is sent through terminal-dedicated signaling, the first configuration information is used for configuring whether the terminal device performs a propagate delay compensation, and the second configuration information is used for configuring whether the terminal device performs the propagate delay compensation.

The processing unit 420 is configured to determine, according to the first configuration information and/or the second configuration information, whether to perform the propagate delay compensation.

In some embodiments, the processing unit 420 is further configured to:
determine to perform the propagate delay compensation when configuration information used for configuring the terminal device to perform the propagate delay compensation exists in configuration information received in the first configuration information and the second configuration information; or
determine not to perform the propagate delay compensation when the configuration information used for configuring the terminal device to perform the propagate delay compensation does not exist in the configuration information received in the first configuration information and the second configuration information.

In some embodiments, the processing unit 420 is further configured to:
determine, according to the first configuration information, whether to perform the propagate delay compensation in a case where the terminal device has received only the first configuration information; or
determine, according to the second configuration information, whether to perform the propagate delay compensation in a case where the terminal device has received only the second configuration information.

In some embodiments, the processing unit 420 is further configured to:
determine, according to the second configuration information, whether to perform the propagate delay compensation in a case where the terminal device has received the first configuration information and the second configuration information; or
determine, according to the first configuration information or the second configuration information, whether to perform the propagate delay compensation in a case where the terminal device has received the first configuration information and the second configuration information; or
determine, according to configuration information with a later reception time between the first configuration information and the second configuration information, whether to perform the propagate delay compensation in a case where the terminal device has received the first configuration information and the second configuration information; or
determine, according to predefined configuration information in the first configuration information and the second configuration information, whether to perform the propagate delay compensation in a case where the terminal device has received the first configuration information and the second configuration information; or
determine, according to configuration information indicated by a network device in the first configuration information and the second configuration information, whether to perform the propagate delay compensation in a case where the terminal device has received the first configuration information and the second configuration information.

In some embodiments, the communicating unit 410 is further configured to:
receive first reference time information and/or second reference time information, where the first reference time information is sent through the broadcast signaling, and the second reference time information is sent through the terminal-dedicated signaling.

In some embodiments, the processing unit 420 is further configured to:
perform the propagate delay compensation according to the first reference time information and/or the second reference time information.

In some embodiments, the processing unit 420 is further configured to:
in a case where the terminal device has received only one piece of reference time information in the first reference time information and the second reference time information, perform the propagate delay compensation according to the one piece of reference time information.

In some embodiments, the processing unit 420 is further configured to:
perform the propagate delay compensation according to the first reference time information or the second reference time information in a case where the terminal device has received the first reference time information and the second reference time information.

In some embodiments, the processing unit 420 is further configured to:
perform the propagate delay compensation according to the first reference time information, or according to reference time information with a later reception time between the first reference time information and the second reference time information, or according to predefined reference time information in the first reference time information and the second reference time information, or according to reference time information configured by the network device in the first reference time information and the second reference time information, in a case where the terminal device has received the first reference time information and the second reference time information and determines, according to the first configuration information, to perform the propagate delay compensation.

In some embodiments, the processing unit 420 is further configured to:
perform the propagate delay compensation according to the second reference time information, or according to reference time information with a later reception time between the first reference time information and the second reference time information, or according to predefined reference time information in the first reference time information and the second reference time information, or according to reference time information configured by the network device in the first reference time information and the second reference time information, in a case where the terminal device has received the first reference time information and the second reference time information and determines, according to the second configuration information, to perform the propagate delay compensation.

In some embodiments, the processing unit 420 is further configured to:
perform the propagate delay compensation according to reference time information with a later reception time between the first reference time information and the second reference time information, or according to predefined reference time information in the first reference time information and the second reference time information, or according to reference time information configured by the network device in the first reference time information and the second reference time information, in a case where the terminal device has received the first reference time information and the second reference time information.

In some embodiments, the first reference time information is used for a propagate delay compensation configured by the first configuration information or the second configuration information, and the second reference time information is used for a propagate delay compensation configured by the second configuration information or the first configuration information.

In some embodiments, the broadcast signaling includes an SIB9 and the terminal-dedicated signaling includes a downlink information transfer command.

Optionally, in some embodiments, the communicating unit may be a communication interface or a transceiver or an input-output interface of a communication chip or a system-on-chip. The processing unit may be one or more processors.

It is to be understood that the terminal device 400 in the embodiments of the present disclosure may correspond to the terminal device in the method embodiments of the present disclosure, and the above and other operations and/or functions of the units in the terminal device 400 are intended to implement the corresponding flow of the terminal device in the method 200 for wireless communication illustrated in FIG. 3 and FIG. 4, respectively, which will not be elaborated herein for the sake of brevity.

FIG. 7 is a schematic block diagram of a network device according to an embodiment of the present disclosure. The network device 500 of FIG. 7 includes a communicating unit 510.

The communicating unit 510 is configured to send target configuration information and/or target reference time information to a terminal device, where the target configuration information is used for configuring whether the terminal device performs propagate delay compensation, and the target reference time information is used for indicating reference time information used for the terminal device to perform the propagate delay compensation.

In some embodiments, the target configuration information is first configuration information and the target reference time information is first reference time information, where the first configuration information is sent through broadcast signaling and the first reference time information is sent through broadcast signaling.

In some embodiments, the target configuration information is second configuration information and the target reference time information is first reference time information or second reference time information, where the second configuration information is sent through terminal-dedicated signaling, the first reference time information is sent through broadcast signaling, and the second reference time information is sent through terminal-dedicated signaling.

In some embodiments, the target configuration information includes first configuration information sent through broadcast signaling and second configuration information sent through terminal-dedicated signaling, and the communicating unit 510 is further configured to:

send third configuration information to the terminal device, where the third configuration information is used for configuring: configuration information used for determining whether the propagate delay compensation is to be performed in the first configuration information and the second configuration information.

In some embodiments, the target reference time information includes first reference time information sent through broadcast signaling and second reference time information sent through terminal-dedicated signaling, and the communicating unit 510 is further configured to: send fourth configuration information to the terminal device, where the fourth configuration information is used for configuring: reference time information used for performing the propagate delay compensation in the first reference time information and the second reference time information.

In some embodiments, the broadcast signaling includes an SIB9.

In some embodiments, the terminal-dedicated signaling includes a downlink information transfer command.

Optionally, in some embodiments, the communicating unit may be a communication interface or a transceiver or an input-output interface of a communication chip or a system-on-chip. The processing unit may be one or more processors.

It is to be understood that the network device 500 in the embodiments of the present disclosure may correspond to the network device in the method embodiments of the present disclosure, and the above and other operations and/or functions of the units in the network device 500 are intended to implement the corresponding flow of the network device in the method 300 for wireless communication illustrated in FIG. 5, respectively, which will not be elaborated herein for brief description.

FIG. 8 is a schematic structural diagram of a communication device 700 according to an embodiment of the present disclosure. The communication device 700 illustrated in FIG. 8 includes a processor 710 that may invoke and run a computer program from a memory to implement the method in the embodiments of the present disclosure.

Optionally, as illustrated in FIG. 8, the communication device 700 may also include a memory 720. The processor 710 may invoke and run a computer program from the memory 720 to implement the method in the embodiments of the present disclosure.

The memory 720 may be a separate device independent of the processor 710 or the memory 720 may be integrated into the processor 710.

Optionally, as illustrated in FIG. 8, the communication device 700 may also include a transceiver 730. The processor 710 may control the transceiver 730 to communicate with other devices, and in particular, to send information or data to other devices, or receive information or data sent by other devices.

The transceiver 730 may include a transmitter and a receiver. The transceiver 730 may further include an antenna(s), the number of which may be one or more.

Optionally, the communication device 700 may be specifically the network device in the embodiments of the present disclosure, and the communication device 700 may implement the corresponding processes implemented by the network device in each method of the embodiments of the present disclosure, which will not be repeated herein for the sake of brevity.

Optionally, the communication device 700 may be specifically a mobile terminal/terminal device of the embodiments of the present disclosure, and the communication device 700 may implement corresponding flows implemented by the mobile terminal/terminal device in each method of the embodiments of the present disclosure, which will not be repeated herein for the sake of brevity.

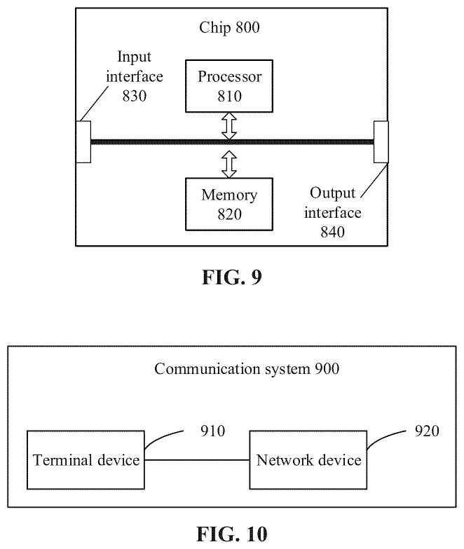

FIG. 9 is a schematic structural diagram of a chip according to an embodiment of the present disclosure. The chip 800 illustrated in FIG. 9 includes a processor 810 that may invoke and run a computer program from a memory to implement the methods in the embodiments of the present disclosure.

Optionally, as illustrated in FIG. 9, the chip 800 may also include a memory 820. The processor 810 may invoke and run a computer program from the memory 820 to implement the methods in the embodiments of the present disclosure.

The memory 820 may be a separate device independent of the processor 810 or may be integrated in the processor 810.

Optionally, the chip 800 may also include an input interface 830. The processor 810 may control the input interface 830 to communicate with other devices or chips, and in particular may obtain information or data sent by other devices or chips.

Optionally, the chip 800 may also include an output interface 840. The processor 810 may control the output interface 840 to communicate with other devices or chips, and in particular may obtain information or data sent by other devices or chips.

Optionally, the chip may be applied to the network device in the embodiments of the present disclosure, and the chip may implement the corresponding flows implemented by the network device in each method of the embodiments of the present disclosure, which will not be repeated herein for the sake of brevity.

Optionally, the chip may be applied to the mobile terminal/terminal device in the embodiments of the present disclosure, and the chip may implement the corresponding flows implemented by the mobile terminal/terminal device in each method of the embodiments of the present disclosure, which will not be repeated herein for the sake of brevity.

It is to be understood that the chips mentioned in the embodiments of the present disclosure may also be referred to may also be a chip, which, for example, may be a system level chip, a system chip, a chip system or an on-chip system chip, etc.

FIG. 10 is a schematic block diagram of a communication system 900 according to an embodiment of the present disclosure. As illustrated in FIG. 10, the communication system 900 includes a terminal device 910 and a network device 920.

The terminal device 910 may be configured to implement the corresponding functions implemented by the terminal device in the above-mentioned methods, and the network device 920 may be configured to implement the corresponding functions implemented by the network device in the above-mentioned methods, which will not be repeated herein for the sake of brevity.

It is to be understood that the processor of the embodiments of the disclosure may be an integrated circuit chip with signal processing capacity. In an implementation process, various steps of the above method embodiments may be completed by an integrated logic circuit of hardware in the processor or an instruction in the form of software. The above processor may be a general-purpose processor, a Digital Signal Processor (DSP), an Application Specific Integrated Circuit (ASIC), a Field Programmable Gate Array (FPGA), or other programmable logic devices, discrete gate or transistor logic devices, and discrete hardware components. Various methods, steps, and logical block diagrams disclosed in the embodiments of the disclosure may be implemented or performed. The general-purpose processor may be a microprocessor, any conventional processor, or the like. Steps of the methods disclosed with reference to the embodiments of the disclosure may be directly performed and accomplished by a hardware decoding processor, or may be performed and accomplished by a combination of hardware and software modules in the decoding processor. The software module may be located in a storage medium mature in the art, such as a random access memory, a flash memory, a read-only memory, a programmable read-only memory or electrically erasable programmable memory, or a register. The storage medium is located in the memory, and the processor reads information in the memory and completes the steps in the foregoing methods in combination with hardware of the processor.

It may be understood that the memory in the embodiments of the disclosure may be a volatile memory or a nonvolatile memory, or may include a volatile memory and a nonvolatile memory. The non-volatile memory may be a read-only memory (Read-Only Memory, ROM), a programmable read-only memory (Programmable ROM, PROM), an erasable programmable read-only memory (Erasable PROM, EPROM), an electrically erasable programmable read-only memory (Electrically EPROM, EEPROM), or a flash memory. The volatile memory may be a RAM, which is used as an external high-speed cache. By way of example but not restrictive description, many forms of RAMs may be used, for example, a Static RAM (SRAM), a Dynamic RAM (DRAM), a Synchronous DRAM (SDRAM), a Double Data Rate SDRAM (DDR SDRAM), an Enhanced SDRAM (ESDRAM), a Synchlink DRAM (SLDRAM), and a Direct Rambus RAM (DR RAM). It is to be noted that the memory of the systems and methods described in this specification includes but is not limited to these and any other proper types of memories.

It is to be understood that the abovementioned memories are exemplary but not restrictive, for example, the memory in the embodiments of the disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM). That is to say, the memories described in the embodiment of the disclosure are intended to include, but not limited to, these and any other suitable types of memories.

The embodiments of the disclosure further provide a computer-readable storage medium, which is configured to store a computer program.

Optionally, the computer-readable storage medium may be applied to the network device in the embodiments of the disclosure. The computer program enables a computer to execute corresponding flows implemented by the network device in each method of the embodiments of the disclosure, which will not be elaborated here for simplicity.

Optionally, the computer-readable storage medium may be applied to the mobile terminal/terminal device in the embodiments of the disclosure. The computer program enables a computer to execute corresponding flows implemented by the mobile terminal/terminal device in each method of the embodiments of the disclosure, which will not be elaborated here for simplicity.

The embodiments of the disclosure further provide a computer program product, which includes a computer program instruction.

Optionally, the computer program product may be applied to a network device in the embodiments of the disclosure. The computer program instruction enables a computer to execute corresponding flows implemented by the network device in each method of the embodiments of the disclosure, which will not be elaborated here for simplicity.

Optionally, the computer program product may be applied to the mobile terminal/terminal device in the embodiments of the disclosure. The computer program instruction enables a computer to execute corresponding flows implemented by the mobile terminal/terminal device in each method of the embodiments of the disclosure, which will not be elaborated herein for simplicity.

The embodiments of the disclosure further provide a computer program.

Optionally, the computer program may be applied to the network device in the embodiments of the disclosure. The computer program runs in a computer to enable the computer to execute corresponding flows implemented by the network device in each method of the embodiments of the disclosure, which will not be elaborated herein for simplicity.

Optionally, the computer program may be applied to the mobile terminal/terminal device in the embodiments of the disclosure. When running on a computer, the computer program enables a computer to execute corresponding flows implemented by the mobile terminal/terminal device in each method of the embodiments of the disclosure, which will not be elaborated here for simplicity.

Those of ordinary skill in the art may be aware that the units and algorithm steps in the examples described with reference to the embodiments disclosed in this specification can be implemented by electronic hardware or a combination of computer software and electronic hardware. Whether the functions are performed by hardware or software depends on particular applications and design constraints of the technical solutions. A person skilled in the art may realize the described functions for each particular disclosure by different methods, but it is not considered that the implementation is beyond the scope of the disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described again herein.

In the several embodiments provided in the disclosure, it is to be understood that the disclosed system, apparatus, and method may be implemented in other modes. For example, the apparatus embodiment described above is only schematic, and for example, division of the units is only logic function division, and other division manners may be adopted during practical implementation. For example, multiple units or components may be combined or integrated into another system, or some characteristics may be neglected or not executed. In addition, the displayed or discussed mutual couplings or direct couplings or communication connections may be implemented by using some interfaces. The indirect couplings or communication connections between the apparatuses or units may be implemented in electronic, mechanical, or other forms.

The units described as separate components may or may not be physically separated, and the components displayed as units may or may not be physical units, and may be located in one place or may be distributed over multiple network units. Some or all of the units may be selected according to actual needs to achieve the objectives of the solutions of the embodiments.

In addition, functional units in various embodiments of the disclosure may be integrated into one processing unit, or each of the units may be physically separated, or two or more units may be integrated into one unit.

When the functions are realized in a form of a software functional unit and sold or used as an independent product, they may be stored in a computer-readable storage medium. In view of this understanding, the technical solutions of the embodiments of the disclosure essentially or the parts that contribute to the prior art, or part of the technical solutions can be embodied in the form of a software product. The computer software product is stored in a storage medium, including multiple instructions for causing a computer device (which may be a personal computer, a server, or a network device, and the like) to execute all or part of the steps of the method described in the embodiments of the disclosure. The foregoing storage medium includes a USB flash disk, a mobile hard disk drive, an ROM, an RAM, and various media that can store program codes, such as a magnetic disk or an optical disk.

The above descriptions are merely specific implementations of the disclosure, but are not intended to limit the scope of protection of the disclosure. Any variation or replacement readily figured out by a person skilled in the art within the technical scope disclosed in the disclosure shall fall within the scope of protection of the disclosure. Therefore, the scope of protection of the disclosure is defined by the scope of protection of the claims.

1. A method for wireless communication, comprising:
receiving, by a terminal device, first configuration information and/or second configuration information, wherein the first configuration information is sent through broadcast signaling, the second configuration information is sent through terminal-dedicated signaling, the first configuration information is used for configuring whether the terminal device performs a propagate delay compensation, and the second configuration information is used for configuring whether the terminal device performs the propagate delay compensation; and
determining, by the terminal device according to the first configuration information and/or the second configuration information, whether to perform the propagate delay compensation.

2. The method of claim 1, wherein determining, by the terminal device according to the first configuration information and/or the second configuration information, whether to perform the propagate delay compensation comprises:
when configuration information used for configuring the terminal device to perform the propagate delay compensation exists in configuration information received in the first configuration information and the second configuration information, determining, by the terminal device, to perform the propagate delay compensation; or
when no configuration information used for configuring the terminal device to perform the propagate delay compensation exists in the configuration information received in the first configuration information and the second configuration information, determining, by the terminal device, not to perform the propagate delay compensation.

3. The method of claim 1, further comprising:
receiving, by the terminal device, first reference time information and/or second reference time information, wherein the first reference time information is sent through the broadcast signaling, and the second reference time information is sent through the terminal-dedicated signaling; and
performing, by the terminal device, the propagate delay compensation according to the first reference time information and/or the second reference time information.

4. The method of claim 3, wherein performing, by the terminal device, the propagate delay compensation according to the first reference time information and/or the second reference time information comprises:
in a case where the terminal device has received only one piece of reference time information in the first reference time information and the second reference time information, performing the propagate delay compensation according to the one piece of reference time information.

5. The method of claim 3, wherein performing, by the terminal device, the propagate delay compensation according to the first reference time information and/or the second reference time information comprises:
in a case where the terminal device has received the first reference time information and the second reference time information, performing the propagate delay compensation according to the first reference time information or the second reference time information.

6. The method of claim 3, wherein performing, by the terminal device, the propagate delay compensation according to the first reference time information and/or the second reference time information comprises:
in a case where the terminal device has received the first reference time information and the second reference time information and determines, according to the first configuration information, to perform the propagate delay compensation, performing the propagate delay compensation according to the first reference time information, or according to reference time information with a later reception time between the first reference time information and the second reference time information, or according to predefined reference time information in the first reference time information and the second reference time information, or according to reference time information configured by the network device in the first reference time information and the second reference time information.

7. The method of claim 3, wherein performing, by the terminal device, the propagate delay compensation according to the first reference time information and/or the second reference time information comprises:
in a case where the terminal device has received the first reference time information and the second reference time information and determines, according to the second configuration information, to perform the propagate delay compensation, performing the propagate delay compensation according to the second reference time information, or according to reference time information with a later reception time between the first reference time information and the second reference time information, or according to predefined reference time information in the first reference time information and the second reference time information, or according to reference time information configured by the network device in the first reference time information and the second reference time information.

8. The method of claim 3, wherein performing, by the terminal device, the propagate delay compensation according to the first reference time information and/or the second reference time information comprises:
in a case where the terminal device has received the first reference time information and the second reference time information, performing the propagate delay compensation according to reference time information with a later reception time between the first reference time information and the second reference time information, or according to predefined reference time information in the first reference time information and the second reference time information, or according to reference time information configured by the network device in the first reference time information and the second reference time information.

9. The method of claim 3, wherein the first reference time information is used for a propagate delay compensation configured by the first configuration information or the second configuration information, and the second reference time information is used for a propagate delay compensation configured by the second configuration information or the first configuration information.

10. A terminal device, comprising: a processor and a memory, wherein the memory is configured to store a computer program, and the processor is configured to invoke and run the computer program stored in the memory to cause the terminal device to:
receive first configuration information and/or second configuration information, wherein the first configuration information is sent through broadcast signaling, the second configuration information is sent through terminal-dedicated signaling, the first configuration information is used for configuring whether the terminal device performs a propagate delay compensation, and the second configuration information is used for configuring whether the terminal device performs the propagate delay compensation; and
determine, according to the first configuration information and/or the second configuration information, whether to perform the propagate delay compensation.

11. The terminal device of claim 10, wherein the processor further causes the terminal device to:
when configuration information used for configuring the terminal device to perform the propagate delay compensation exists in configuration information received in the first configuration information and the second configuration information, determine to perform the propagate delay compensation; or
when no configuration information used for configuring the terminal device to perform the propagate delay compensation exists in the configuration information received in the first configuration information and the second configuration information, determine not to perform the propagate delay compensation.

12. The terminal device of claim 10, wherein the processor further causes the terminal device to:
receive first reference time information and/or second reference time information, wherein the first reference time information is sent through the broadcast signaling, and the second reference time information is sent through the terminal-dedicated signaling; and
perform the propagate delay compensation according to the first reference time information and/or the second reference time information.

13. The terminal device of claim 12, wherein the processor further causes the terminal device to:
in a case where the terminal device has received only one piece of reference time information in the first reference time information and the second reference time information, perform the propagate delay compensation according to the one piece of reference time information.

14. The terminal device of claim 12, wherein the first reference time information is used for a propagate delay compensation configured by the first configuration information or the second configuration information, and the second reference time information is used for a propagate delay compensation configured by the second configuration information or the first configuration information.

15. A network device, comprising: a processor and a memory, wherein the memory is configured to store a computer program, and the processor is configured to invoke and run the computer program stored in the memory to cause the network device to:
send target configuration information and/or target reference time information to a terminal device, wherein the target configuration information is used for configuring whether the terminal device performs propagate delay compensation, and the target reference time information is used for indicating reference time information used for the terminal device to perform the propagate delay compensation.

16. The network device of claim 15, wherein the target configuration information is first configuration information, and the target reference time information is first reference time information, wherein the first configuration information is sent through broadcast signaling and the first reference time information is sent through broadcast signaling.

17. The network device of claim 15, wherein the target configuration information is second configuration information, and the target reference time information is first reference time information or second reference time information, wherein the second configuration information is sent through terminal-dedicated signaling, the first reference time information is sent through broadcast signaling, and the second reference time information is sent through terminal-dedicated signaling.

18. The network device of claim 15, wherein the target configuration information comprises first configuration information sent through broadcast signaling and second configuration information sent through terminal-dedicated signaling, and the processor further causes the network device to:
send third configuration information to the terminal device, wherein the third configuration information is used for configuring: configuration information used for determining whether the propagate delay compensation is to be performed in the first configuration information and the second configuration information.

19. The network device of claim 15, wherein the target reference time information comprises first reference time information sent through broadcast signaling and second reference time information sent through terminal-dedicated signaling, and the processor further causes the network device to:
send fourth configuration information to the terminal device, wherein the fourth configuration information is used for configuring: reference time information used for performing the propagate delay compensation in the first reference time information and the second reference time information.

20. The network device of claim 17, wherein the broadcast signaling comprises a System Information Block (SIB) 9, and the terminal-dedicated signaling comprises a downlink information transfer command.
